(19) United States
(12) Patent Application Publication
(10) Pub. No.: US 2024/0121637 A1
(43) Pub. Date: Apr. 11, 2024

(54) WIRELESS COMMUNICATION MONITORING SYSTEM, WIRELESS COMMUNICATION MONITORING METHOD, AND MONITORING DEVICE

(71) Applicant: NIPPON TELEGRAPH AND TELEPHONE CORPORATION, Tokyo (JP)

(72) Inventors: Akira MATSUSHITA, Musashino-shi, Tokyo (JP); Mitsuru NISHINO, Musashino-shi, Tokyo (JP); Munehiro MATSUI, Musashino-shi, Tokyo (JP); Masaki SHIMA, Musashino-shi, Tokyo (JP); Koichi HARADA, Musashino-shi, Tokyo (JP); Hiroki SHIBAYAMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/275,412

(22) PCT Filed: Feb. 17, 2021
(86) PCT No.: PCT/JP2021/005921

§ 371 Date: Aug. 2, 2023

(51) Int. Cl. H04W 24/04; H04W 24/08

(52) U.S. Cl. CPC H04W 24/04; H04W 24/08

(57) ABSTRACT

A wireless communication monitoring system for monitoring a hardware failure of a wireless communication unit of a wireless communication device using a remote monitoring control device, in which the wireless communication device transmits or receives a predetermined radio signal to or from a monitoring device added or attached to the host device to perform a life and death check for checking an operation, and the remote monitoring control device detects a hardware failure of the wireless communication unit of the wireless communication device on the basis of a result of the life and death check received from the wireless communication device. This makes it possible to detect a failure that cannot be detected from information obtained from a device state request to a wireless communication device of the related art.

### TECHNICAL FIELD

The present invention relates to a technology for detecting a failure in a wireless communication unit of a wireless communication device using a monitoring device.

### BACKGROUND ART

Generally, in a wireless communication system, an operation of wireless communication devices is monitored and detection of a failure is performed. For example, in a wireless local area network (LAN) system, the simple network management protocol (SNMP) for collecting a life and death check using a ping command (a check as to whether the wireless LAN access point is operating normally) or a detailed device status is used in order for a wireless LAN controller to monitor an operation of a wireless LAN access point (see NPL 1 and NPL 2, for example).

### CITATION LIST

### Non Patent Literature

[NPL 1]
https://xtech.nikkei.com/it/members/NCC/NETPOINT/20021126/3/
[NPL 2]
https://xtech.nikkei.com/it/members/NCC/NETPOINT/20021126/3/

### SUMMARY OF INVENTION

### Technical Problem

Since a ping in the related art is performed from the wireless LAN controller to a LAN interface of the wireless LAN access point, there is a problem that an abnormality in a wireless section including a wireless communication circuit cannot be detected. Further, the SNMP can monitor for a hardware failure, traffic flow rate information, or the like by acquiring a management information base (MIB) for checking various types of status information defined in the device, but hardware failure not reflected in the MIB cannot be detected.

However, even when there is a hardware failure that cannot be detected by the MIB, a failure can be detected in some cases when a normal wireless LAN access point is installed separately from a wireless LAN access point in which the failure has occurred on the same floor of an office. For example, it is possible to detect features such as unnaturally low traffic only at a wireless LAN access point in which a failure has occurred and indirectly detect a hardware failure by monitoring and comparing traffic flow rates of main signals of wireless LAN access points.

However, in a case in which there is only one device per site, as in a public wireless LAN access point deployed in a convenience store, a hardware failure that cannot be detected by the MIB cannot be subjected to indirect detection as described above. Further, there is a problem that, when no main signal traffic flows through the access point, it is impossible to distinguish between whether radio waves of a wireless LAN are not transmitted due to a hardware failure of the wireless communication unit and whether the hardware is normal but there are simply no users.

An object of the present invention is to provide a wireless communication monitoring system, a wireless communication monitoring method, and a monitoring device capable of detecting a failure that cannot be detected only with information obtained from a device state request to a wireless communication device as in the related art, by adding or attaching a monitoring device to a wireless communication device and performing a life and death check between the wireless communication device and the monitoring device.

### Solution to Problem

The present invention is a wireless communication monitoring system for monitoring for a hardware failure of a wireless communication unit of at least one wireless communication device using a remote monitoring control device, wherein the wireless communication device transmits or receives a predetermined radio signal to or from a monitoring device added or attached to the host device to perform a life and death check for checking an operation, and the remote monitoring control device performs a determination of a failure including a hardware failure of the wireless communication unit of the wireless communication device on the basis of a device state response of the wireless communication device including a result of the life and death check received from the wireless communication device.

Further, the present invention is a wireless communication monitoring method for monitoring for a hardware failure of a wireless communication unit of at least one wireless communication device using a remote monitoring control device, wherein the wireless communication device transmits or receives a predetermined radio signal to or from a monitoring device added or attached to the host device to perform a life and death check for checking an operation, and the remote monitoring control device performs a determination of a failure including the hardware failure of the wireless communication unit of the wireless communication device on the basis of a device state response of the wireless communication device including a result of the life and death check received from the wireless communication device.

Further, the present invention provides a monitoring device including: a power generation unit added or attached to a wireless communication device and configured to generate power required for an operation using radio waves radiated from the wireless communication device; a wireless communication unit configured to perform wireless communication with the wireless communication device; and a monitoring control unit configured to return a response signal when a predetermined life and death check signal for checking the presence or absence of an operation is received from the wireless communication device via the wireless communication unit.

### Advantageous Effects of Invention

With the wireless communication monitoring system, the wireless communication monitoring method, and the monitoring device according to the present invention, it is possible to detect a failure that cannot be detected only with information obtained from a device state request to a wireless communication device as in the related art, by adding or attaching a monitoring device to a wireless communication device and performing a life and death check between the wireless communication device and the monitoring device.

### BRIEF DESCRIPTION OF DRAWINGS

FIG. 1 is a diagram illustrating an example of a wireless communication monitoring system according to the present embodiment.

FIG. 2 is a diagram illustrating an example of a wireless communication monitoring system of a comparative example.

FIG. 3 is a diagram illustrating an example of a wireless communication device.

FIG. 4 is a diagram illustrating another example of the wireless communication device.

FIG. 5 is a diagram illustrating an example of a monitoring device of the wireless communication monitoring system according to the present embodiment.

FIG. 6 is a diagram illustrating an example of a monitoring sequence of the wireless communication monitoring system according to the present embodiment.

FIG. 7 is a diagram illustrating an example of a monitoring sequence of a wireless communication monitoring system of a comparative example.

FIG. 8 is a diagram illustrating a configuration example of a wireless LAN monitoring system according to the present embodiment.

FIG. 9 is a diagram illustrating a configuration example of a wireless LAN monitoring system of a comparative example.

FIG. 10 is a diagram illustrating an example of a wireless LAN access point according to the present embodiment.

FIG. 11 is a diagram illustrating a configuration example of the monitoring device of the wireless LAN monitoring system according to the present embodiment.

FIG. 12 is a diagram illustrating an example of a monitoring sequence of the wireless LAN monitoring system according to the present embodiment.

FIG. 13 is a diagram illustrating an example of a monitoring sequence of a wireless LAN monitoring system of the comparative example.

FIG. 14 is a diagram illustrating an example of failure isolation processing in the wireless LAN monitoring system.

### DESCRIPTION OF EMBODIMENTS

Hereinafter, embodiments of a wireless communication monitoring system, a wireless communication monitoring method, and a monitoring device according to the present invention will be described with reference to the drawings.

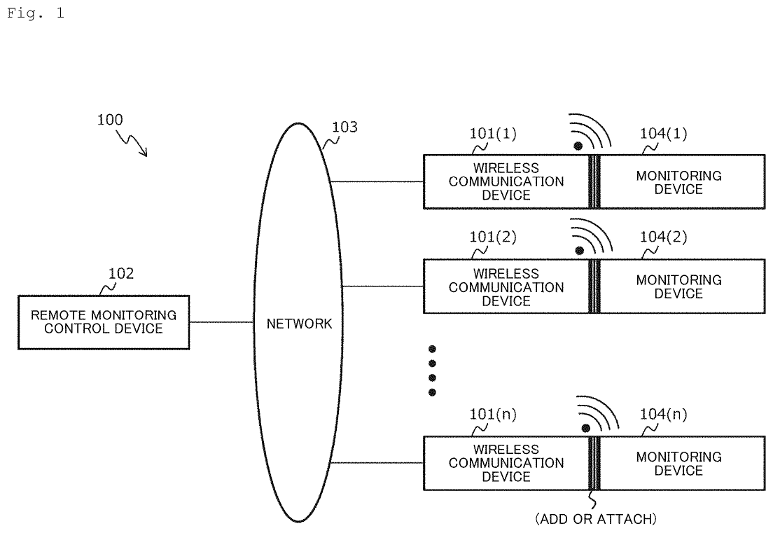

FIG. 1 illustrates an example of a wireless communication monitoring system 100 according to the present embodiment. In FIG. 1, the wireless communication monitoring system 100 includes a wireless communication device 101(1), a wireless communication device 101(2), . . . , a wireless communication device 101(n), a monitoring device 104(1), a monitoring device 104(2), . . . , a monitoring device 104(n), and a remote monitoring control device 102. Here, in description common to n wireless communication devices (n is a positive integer) from the wireless communication device 101(1) to the wireless communication device 101(n), (number) at an end of the reference sign is omitted and the wireless communication device is described as a wireless communication device 101. The monitoring devices 104(1) to 104(n) are similarly described.

In FIG. 1, n wireless communication devices 101 and the remote monitoring control device 102 can communicate with each other via a network 103.

The wireless communication device 101 is connected to a wireless terminal such as a smartphone, and the wireless terminal can access other wireless terminals, the Internet, or the like via the wireless communication device 101 and the network 103.

The remote monitoring control device 102 monitors a device state of the n wireless communication devices 101 via the network 103 and detects a failure.

The network 103 is configured of, for example, network devices compatible with Internet Protocol (IP), and devices connected to the network 103 can communicate with each other.

The monitoring device 104 is added or attached to each of the n wireless communication devices 101, and performs predetermined wireless communication with wireless communication devices 101 to which the monitoring device 104 has been the added or attached, so that a failure in a wireless communication unit (a wireless communication unit 201 to be described below) in the wireless communication device 101 can be detected. Further, in the present embodiment, the monitoring device 104 can obtain power for an operation from radio waves when the wireless communication device 101 performs wireless communication.

Thus, the wireless communication monitoring system 100 according to the present embodiment can monitor the device state of at least one wireless communication device 101 and detect a failure of the wireless communication device 101 using the remote monitoring control device 102. In particular, in the present embodiment, it is possible to detect a hardware failure of the wireless communication unit of the wireless communication device 101, which was difficult to detect a failure using a MIB of the SNMP for acquiring a device state as in the related art, by using the monitoring device 104.

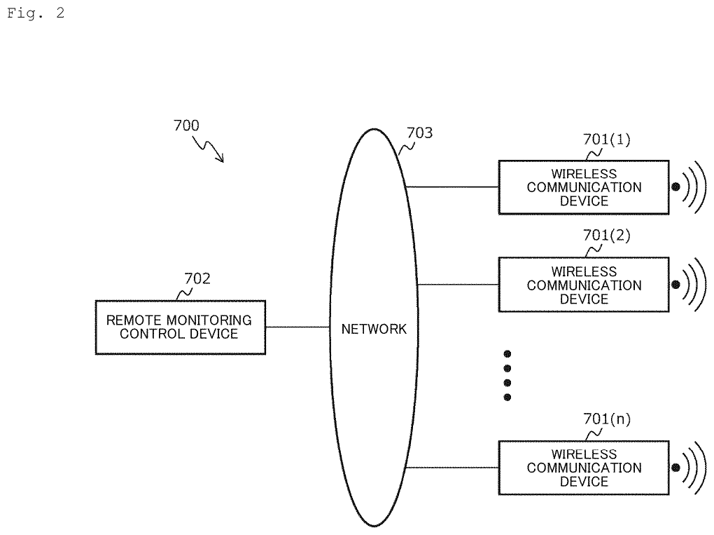

FIG. 2 illustrates an example of a wireless communication monitoring system 700 of a comparative example. In FIG. 2, the wireless communication monitoring system 700 includes wireless communication devices 701(1) to 701(n) and a remote monitoring control device 702, and communicates via a network 703.

Here, the wireless communication device 701, the remote monitoring control device 702, and the network 703 in the comparative example correspond to the wireless communication device 101, the remote monitoring control device 102, and the network 103 in FIG. 1, respectively. However, since the remote monitoring control device 702 of the comparative example performs failure detection using MIB of SNMP for acquiring the device state as in the related art, it is difficult to detect a hardware failure of the wireless communication unit of the wireless communication device 701. There is a problem that, for example, when no main signal traffic flows through the wireless communication device 701, it is impossible to distinguish between whether radio waves are not transmitted due to a hardware failure of the wireless communication unit and whether the hardware of the wireless communication unit is normal but there are simply no users.

On the other hand, in the wireless communication monitoring system 100 according to the present embodiment illustrated in FIG. 1, since it is possible to check whether or not the wireless communication unit of the wireless communication device 101 is operating by performing predetermined wireless communication between the monitoring device 104 added or attached to the wireless communication device 101 and the wireless communication device 101, it is possible to detect the hardware failure of the wireless communication unit. A specific detection method will be described below in detail.

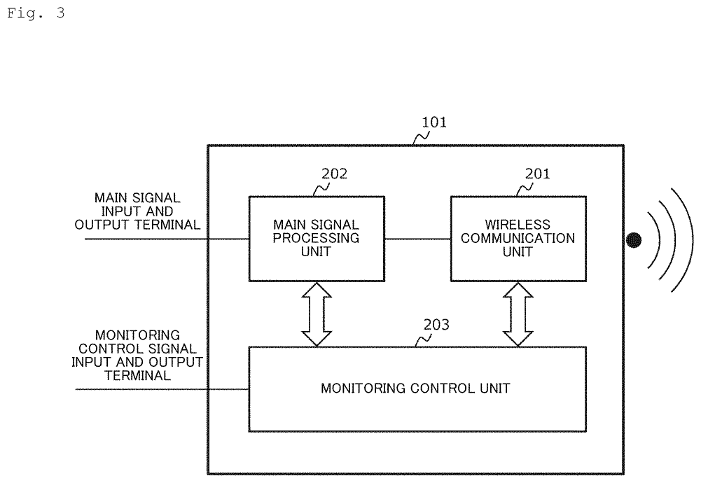

FIG. 3 illustrates an example of the wireless communication device 101. In FIG. 3, the wireless communication device 101 includes a wireless communication unit 201, a main signal processing unit 202, and a monitoring control unit 203.

The wireless communication unit 201 performs wireless communication with a wireless terminal connected to the host device. For example, the wireless communication unit 201 converts a radio frame input from the main signal processing unit 202 into a radio signal and transmits the radio signal to the wireless terminal, and converts a radio signal received from the wireless terminal into a radio frame and outputs the radio frame to the main signal processing unit 202. Further, the wireless communication unit 201 can check whether or not a normal operation is performed (life and death check) by performing predetermined wireless communication with the monitoring device 104 added or attached to the host device.

The main signal processing unit 202 includes input and output terminals for the main signal traffic, and performs input and output of the main signal traffic with another device connected via the network 103. For example, the main signal processing unit 202 converts the main signal traffic input from the network 103 into a radio frame, outputs the radio frame to the wireless communication unit 201, converts the radio frame input from the wireless communication unit 201 into main signal traffic, and outputs the main signal traffic to the network 103.

The monitoring control unit 203 faces the remote monitoring control device 102, and the remote monitoring control device 102 performs a setting and control, and the like on each unit in the host device. Further, the monitoring control unit 203 notifies the remote monitoring control device 102 of information such as acquisition of the device state of the host device and collection and management of alarm information (warnings or the like) within the host device. Here, a signal transmitted and received between the monitoring control unit 203 and the remote monitoring control device 102 is referred to as a monitoring control signal. The monitoring control unit 203 includes a monitoring control signal input and output terminal, and inputs or outputs the monitoring control signal to and from the remote monitoring control device 102 via the network 103. For example, the monitoring control unit 203 receives the monitoring control signal via the network 103, and performs setting, control, and the like on the wireless communication unit 201, the main signal processing unit 202, and the wireless communication unit 201 on the basis of the monitoring control signal. Further, the monitoring control unit 203 transmits information obtained from the respective units of the wireless communication device 101 such as the wireless communication unit 201 and the main signal processing unit 202 to the remote monitoring control device 102 via the network 103 using the monitoring control signal. In particular, in the present embodiment, the monitoring control unit 203 performs life and death check communication with the monitoring device 104 added or attached to the host device using the wireless communication unit 201, and transmits the device state response including a result of the life and death check to the remote monitoring control device 102.

Thus, in the wireless communication monitoring system 100 according to the present embodiment, the wireless communication device 101 performs a life and death check with the monitoring device 104 added or attached to the host device, and transmits a device state including the result of the life and death check to the remote monitoring control device 102. This makes it possible for the remote monitoring control device 102 to detect the failure including the hardware failure of the wireless communication unit of the wireless communication device 101.

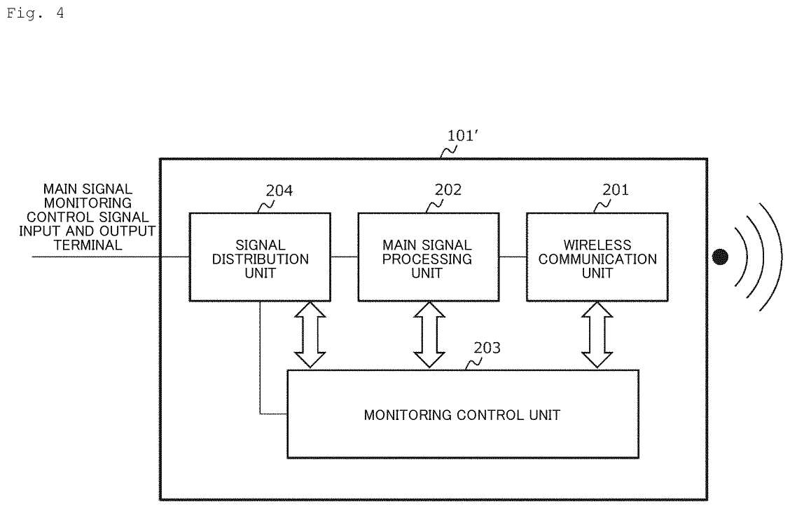

FIG. 4 illustrates an example of a wireless communication device 101′. FIG. 4 illustrates another example of the wireless communication device 101 described with reference to FIG. 3, and the wireless communication device 101 in the other example differs from the wireless communication device 101 that the wireless communication device 101 in the other example includes a signal distribution unit 204. In FIG. 4, since the wireless communication unit 201, the main signal processing unit 202, and the monitoring control unit 203 have the same functions as blocks denoted by the same reference signs in FIG. 3, repeated description will be omitted. In the wireless communication device 101 of FIG. 3, the main signal traffic input and output terminal and the monitoring control signal input and output terminal are provided separately, whereas in the wireless communication device 101′ of FIG. 4, the main signal traffic input and output terminal and the monitoring control signal input and output terminal are integrated into one input and output terminal, and both the main signal and the monitoring control signal are input or output to or from the one input and output terminal. The signal distribution unit 204 determines a signal input from the one input and output terminal, and performs signal distribution so that the signal is output in the main signal processing unit 202 when the signal is the main signal traffic, and outputs the monitoring control signal to the monitoring control unit 203 when the signal is the monitoring control signal.

In FIG. 4, the main signal traffic transmitted from the main signal processing unit 202 is output from the signal distribution unit 204 to the network 103, and the monitoring control signal transmitted from the monitoring control unit 203 is output from the signal distribution unit 204 to the network 103. Here, a configuration of the wireless communication device 101′ illustrated in FIG. 4 includes only one input and output terminal, for example, like an access point of a wireless LAN, and corresponds to a system in which both the main signal and the monitoring control signal are mixed in the input and output terminal.

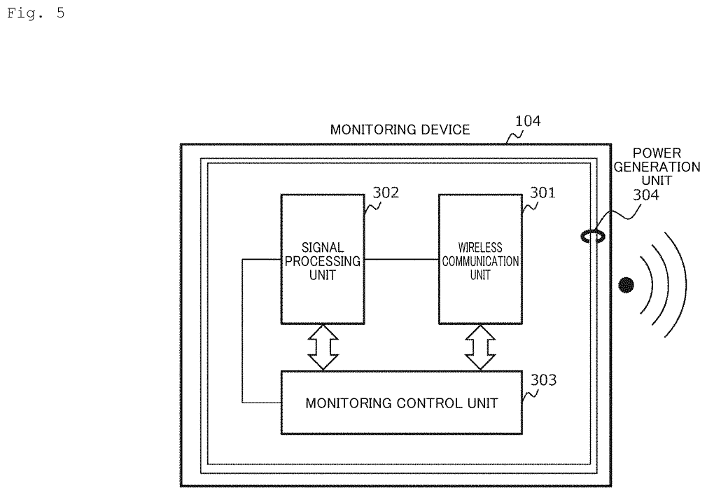

FIG. 5 illustrates an example of the monitoring device 104 according to the present embodiment. The monitoring device 104 is added or attached to the wireless communication device 101 and used, as described with reference to FIG. 1. A method for addition or attachment to the wireless communication device 101 may be any method that is commonly used, such as a hook, screw, and adhesive.

In FIG. 5, the monitoring device 104 includes a wireless communication unit 301, a signal processing unit 302, a monitoring control unit 303, and a power generation unit 304.

The wireless communication unit 301 converts a radio frame output from the signal processing unit 302 into radio waves, transmits the radio frame to the wireless communication device 101, converts a radio wave received from the wireless communication device 101 into a radio frame, and outputs the radio frame to the signal processing unit 302. For example, the wireless communication unit 301 performs wireless communication with the added or attached wireless communication device 101, and transmits a response signal to the wireless communication device 101 when receiving a life and death check signal (such as a ping signal) from the wireless communication device 101.

The signal processing unit 302 converts the transmission signal output from the monitoring control unit 303 into a radio frame, outputs the radio frame to the wireless communication unit 301, and converts the radio frame input from the wireless communication unit 301 into a reception signal. For example, the signal processing unit 302 receives a radio frame including a life and death check signal received from the wireless communication device 101 by the wireless communication unit 301, converts the radio frame into a life and death check signal, and outputs the life and death check signal to the monitoring control unit 303. On the other hand, the signal processing unit 302 converts a life and death check response signal output from the monitoring control unit 303 into a radio frame, and outputs the radio frame to the wireless communication unit 301. Further, the signal processing unit 302 converts the information transmitted or received to or from the wireless communication device 101 by the monitoring control unit 303 into a radio frame as necessary, such as when establishing a link with the wireless communication device 101, and transmits or receives the radio frame using the wireless communication unit 301.

The monitoring control unit 303 inputs or outputs monitoring control information to and from the wireless communication unit 301 and the signal processing unit 302 and manages the monitoring control information, and performs communication with the monitoring control unit 203 of the wireless communication device 101 that is an addition or attachment destination. Specifically, when the monitoring control unit 303 receives a life and death check request from the wireless communication device 101, the monitoring control unit 303 performs processing for returning the life and death check response to the wireless communication device 101, or processing for link establishment with the wireless communication device 101, for example.

The power generation unit 304 receives radio waves emitted by the wireless communication device 101 that is an addition or attachment destination, to generate power used for the monitoring device 104 to transmit the radio waves, and supplies the power to each unit within the host device. This makes it possible for the monitoring device 104 according to the present embodiment to operate without being supplied with power from the outside, and to communicate with the wireless communication device 101. For example, the power generation unit 304 can be realized by a resonance circuit that converts the radio waves emitted by the wireless communication device 101 into power, a capacitor that stores the generated power, and the like. The monitoring device 104 can communicate in the same way as a wireless terminal or the like using radio waves used for communication by the wireless communication device 101, and can also be considered as one of wireless terminals fixed to the wireless communication device 101 to which a communication destination has been added or attached.

Thus, the monitoring device 104 is added or attached to the wireless communication device 101, and can perform life and death check with the wireless communication device 101. The wireless communication device 101 obtains a result of life and death check with the monitoring device 104 and transmits the device state including a result of the life and death check to the remote monitoring control device 102. This makes it possible for the remote monitoring control device 102 to detect the hardware failure of the wireless communication unit 201 of the wireless communication device 101.

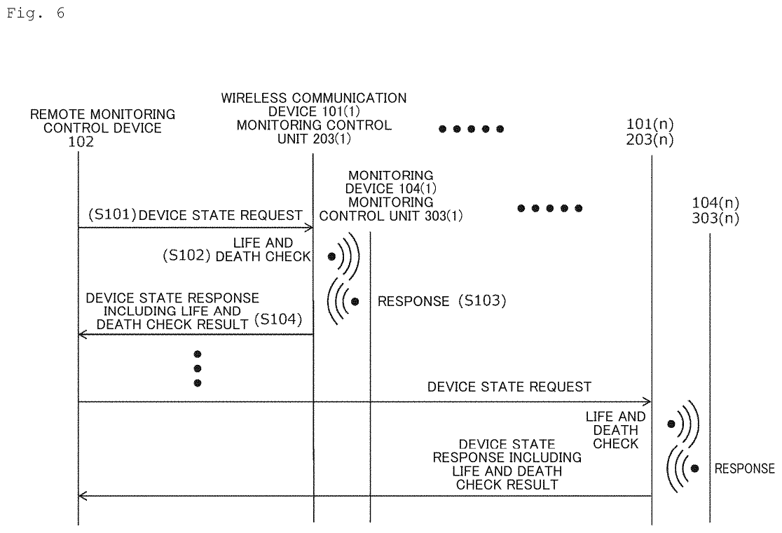

FIG. 6 illustrates an example of a monitoring sequence of the wireless communication monitoring system 100 according to the present embodiment. The sequence in FIG. 6 is executed by the remote monitoring control device 102, the monitoring control unit 203 of the wireless communication device 101, and the monitoring control unit 303 of the monitoring device 104.

In step S101, in order to monitor the n wireless communication devices 101 that are management targets, the remote monitoring control device 102 requests the monitoring control unit 203 of each wireless communication device 101 for information on the device state one by one (device state request).

In step S102, the monitoring control unit 203 of each wireless communication device 101 that has received the device state request from the remote monitoring control device 102 performs the life and death check on the monitoring control unit 303 of the monitoring device 104.

In step S103, the monitoring control unit 303 of the monitoring device 104 returns a response to the life and death check to the wireless communication device 101 when the monitoring control unit 303 receives the life and death check from the wireless communication device 101.

In step S104, the monitoring control unit 203 of the wireless communication device 101 transmits information such as the held device state of the host device or alarm, including the result of the life and death check with the monitoring device 104 (presence or absence of a response), to the remote monitoring control device 102 (the device state response).

Here, when the monitoring control unit 203 of the wireless communication device 101 receives a life and death check response from the monitoring device 104, the monitoring control unit 203 recognizes that the life and death check with the monitoring device 104 has succeeded.

The above-described sequence is similarly executed for the n wireless communication devices 101 from the wireless communication device 101(1) to the wireless communication device 101(n).

The remote monitoring control device 102 collects the device state of each wireless communication device 101 including the result of the life and death check with the monitoring device 104 added or attached to each wireless communication device 101 from the n wireless communication devices 101. In the present embodiment, since the remote monitoring control device 102 performs failure detection using the result of life and death check with the monitoring device 104 added or attached to the wireless communication device 101, it is possible to detect the failure including the hardware failure of the wireless communication unit 201 of the wireless communication device 101. For example, a determination can be made that the hardware failure is likely to occur in the wireless communication unit 201 of the wireless communication device 101 when there is no life and death check response from the monitoring device 104, although the wireless communication device 101 can be determined to be normal due to no failure being detected in a method (ping or SNMP) of the related art.

As described above, in the wireless communication monitoring system 100 according to the present embodiment, the wireless communication device 101 performs life and death check with the monitoring device 104 added or attached to the host device, and notifies the remote monitoring control device 102 of the device state of the host device including the result of the life and death check. The remote monitoring control device 102 can detect the failure including the hardware failure of the wireless communication unit 201 of the wireless communication device 101, on the basis of the device state of the host device including the result of the life and death check.

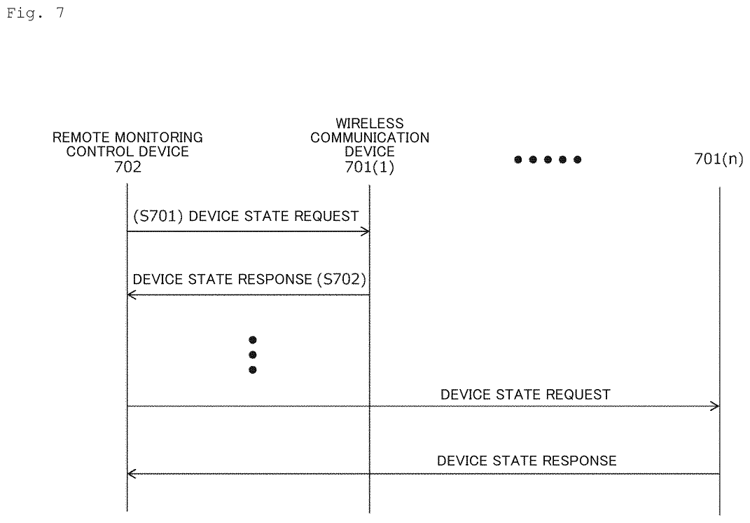

FIG. 7 illustrates an example of a monitoring sequence of wireless communication monitoring system 700 of the comparative example. The remote monitoring control device 702 requests the monitoring control unit (corresponding to the monitoring control unit 203 in FIG. 3) of each wireless communication device 701 for the information on the device state one by one in order to monitor the n wireless communication devices 701 that are management target (S701: device state request). The monitoring control unit of each wireless communication device 701 that has received the device state request responds with information such as the held device state or alarm (S702: device state response).

Thus, in the wireless communication monitoring system 700 of the comparative example, since the device state request transmitted from the remote monitoring control device 702 to the wireless communication device 701 in step S701, and only the device state response returned from the wireless communication device 701 to the remote monitoring control device 702 in step S702 are performed, there is a problem that it is difficult to detect a failure that cannot be acquired as the device state.

On the other hand, in the monitoring sequence of the wireless communication monitoring system 100 according to the present embodiment illustrated in FIG. 6, it is possible to detect the hardware failure of the wireless communication unit 201 by performing the life and death check with monitoring device 104 added or attached to the wireless communication device 101 to check whether the wireless communication unit 201 of the wireless communication device 101 is operating.

(Example of Application to Wireless LAN)

Next, an example in which the wireless communication monitoring system 100 according to the embodiment described above is applied to a wireless LAN will be described.

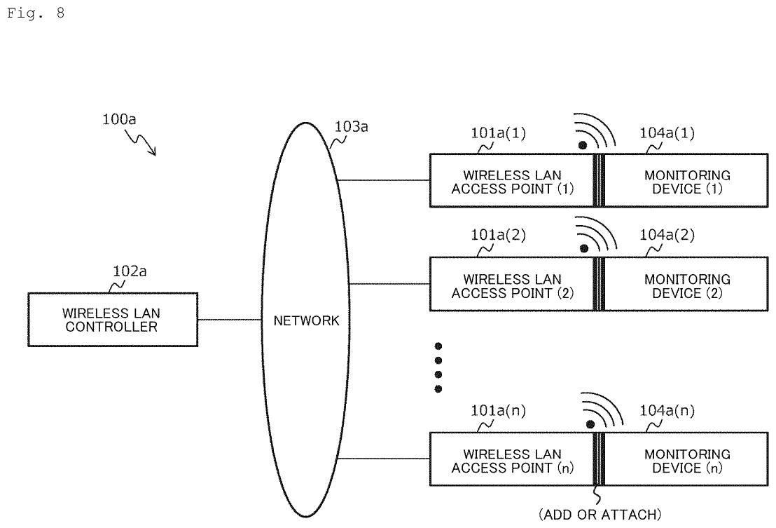

FIG. 8 illustrates a configuration example of a wireless LAN monitoring system 100a according to the present embodiment. The wireless LAN monitoring system 100a illustrated in FIG. 8 is an example in which the wireless communication monitoring system 100 described in FIG. 1 is replaced with a wireless LAN.

In FIG. 8, the wireless LAN monitoring system 100a includes a wireless LAN access point 101a(1), a wireless LAN access point 101a(2), a wireless LAN access point 101a(n), a monitoring device 104a(1), a monitoring device 104a(2), a monitoring device 104a(n), and a wireless LAN controller 102a, and these can communicate with each other via a network 103a. Here, in description common to n access points (n is a positive integer) from the wireless LAN access point 101a(1) to the wireless LAN access point 101a(n), (number) at an end of the reference sign is omitted and the access point is described as a wireless LAN access point 101a. The monitoring devices 104a(1) to 104a(n) are similarly described.

In FIG. 8, the wireless LAN controller 102a communicates with the n wireless LAN access points 101a via the network 103a and acquires the device information including the result of life and death check with the n monitoring devices 104a added or attached to the n wireless LAN access points 101a This makes it possible for the wireless LAN controller 102a to detect the hardware failure of the wireless LAN access point 101a.

In FIG. 8, the wireless LAN access point 101a has a DHCP server function, and can issue an IP address to a terminal (a wireless terminal such as smartphones) connected to the wireless LAN access point 101a.

Further, the monitoring device 104a is one of the terminals connected to the wireless LAN access point 101a, but an IP address is not issued to the monitoring device 104a by the DHCP server, and a predetermined fixed IP address is assigned. This is intended to prevent an IP address from being unable to be issued to a new monitoring device 104a and, as a result, the life and death check (ping) from the wireless LAN access point 101a to the monitoring device 104a from being unable to be performed when the monitoring device 104a is replaced due to a fault or the like in a situation in which the DHCP server has run out of IP addresses.

Successful life and death check (ping) to the monitoring device 104a from the wireless LAN access point 101a may mean that each block of the wireless LAN access point 101a related to ping is normal and, in particular, radio waves of the wireless LAN are normally transmitted and received.

Further, when the wireless LAN access point 101a cannot detect the failure even though a wireless communication unit (the wireless communication unit 201a to be described below) of the wireless LAN access point 101a fails and radio waves are not transmitted, the response to the device state request using SNMP is only returned as normal, and thus, the failure as described above cannot be detected in the case of the related art. However, in the wireless LAN monitoring system 100a according to the present embodiment, since a failure determination is actually performed including the result of the life and death check (ping) to the monitoring device 104a using radio waves of the wireless LAN, it is possible to detect the failure as described above.

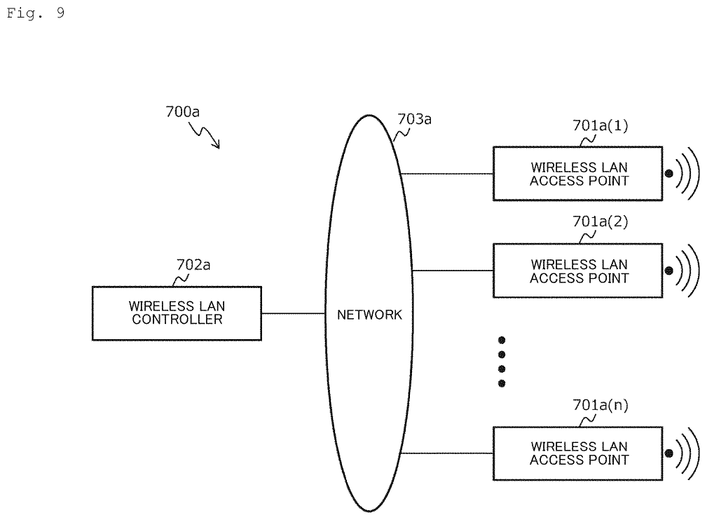

FIG. 9 illustrates a configuration example of a wireless LAN monitoring system 700a of a comparative example. In FIG. 9, the wireless LAN monitoring system 700a of the comparative example includes s a wireless LAN access point 701a(1), a wireless LAN access point 701a(2), a wireless LAN access point 701a(n), and a wireless LAN controller 702a, and theses can communicate with each other via a network 703a.

Here, the wireless LAN access point 701a, the wireless LAN controller 702a, and the network 703a in the comparative example correspond to the wireless LAN access point 101a, the wireless LAN controller 102a, and the network 103a in FIG. 8, but it is difficult for the wireless LAN controller 702a to detect a hardware failure of a wireless communication unit (not illustrated) of the wireless LAN access point 701a. There is a problem that, for example, when no wireless Lan signal flows through the wireless LAN access point 701a, it is impossible to distinguish between whether radio waves are not transmitted due to a hardware failure of the wireless communication unit and whether the hardware of the wireless communication unit is normal but there are simply no users.

On the other hand, in the wireless LAN monitoring system 100a according to the present embodiment illustrated in FIG. 8, the wireless LAN access point 101a performs a life and death check using ping on the monitoring device 104a added or attached to the host device. This makes it possible for the wireless LAN controller 102a to check whether or not the wireless communication unit of the wireless LAN access point 101a is operating, on the basis of the presence or absence of the ping response.

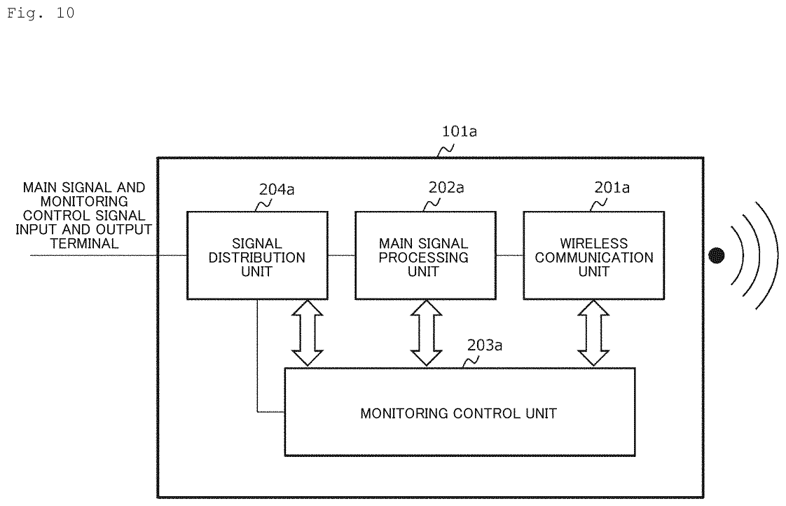

FIG. 10 illustrates an example of the wireless LAN access point 101a according to the present embodiment. In FIG. 10, the wireless LAN access point 101a includes a wireless communication unit 201a, a main signal processing unit 202a, a monitoring control unit 203a, and a signal distribution unit 204a. Here, the wireless communication unit 201a, the main signal processing unit 202a, the monitoring control unit 203a, and the signal distribution unit 204a correspond to the wireless communication unit 201, the main signal processing unit 202, the monitoring control unit 203, and the signal distribution unit 204 illustrated in FIG. 4, and operate in the same manner as the wireless communication device 101 in FIG. 4 except that a wireless LAN frame is handled as a radio frame, a DHCP server function is included, and an IP address is issued to a connection terminal.

In FIG. 10, the monitoring control unit 203a includes an input and output terminal for the main signal and the monitoring control signal, and transmits or receives the main signal to or from a communication destination device via the network 103a, or transmits or receives the monitoring control signal to or from the wireless LAN controller 102a. For example, the monitoring control unit 203a receives the monitoring control signal via the network 103a, and controls the wireless communication unit 201a, the main signal processing unit 202a, and the signal distribution unit 204a on the basis of the monitoring control signal. Further, the monitoring control unit 203a performs a life and death check with the monitoring device 104a added or attached to the host device, and transmits the device state including the result of the life and death check via the network 103a to the wireless LAN controller 102a using the monitoring control signal.

Further, the wireless LAN access point 101a has a DHCP server function, and can issue an IP address to a terminal (a wireless terminal such as a smartphone) connected to the wireless LAN access point 101a. The monitoring device 104a is one of the terminals connected to the wireless LAN access point 101a, but an IP address is not issued to the monitoring device 104a by the DHCP server, and a predetermined fixed IP address is assigned.

Here, when the monitoring control unit 203a cannot detect a failure even though the failure occurs in the wireless communication unit 201a of the wireless LAN access point 101a and radio waves are not transmitted, the wireless LAN controller 102a only returns the response to the device state request using SNMP from the wireless LAN access point 101a as normal, and thus, the failure as described above cannot be detected in the case of the related art. However, in the present embodiment, since the wireless LAN access point 101a performs the life and death check (ping) to the monitoring device 104a using actual wireless LAN radio waves and transmits the device state response including the result of the life and death check to the wireless LAN controller 102a, the wireless LAN controller 102a can detect the failure as described above.

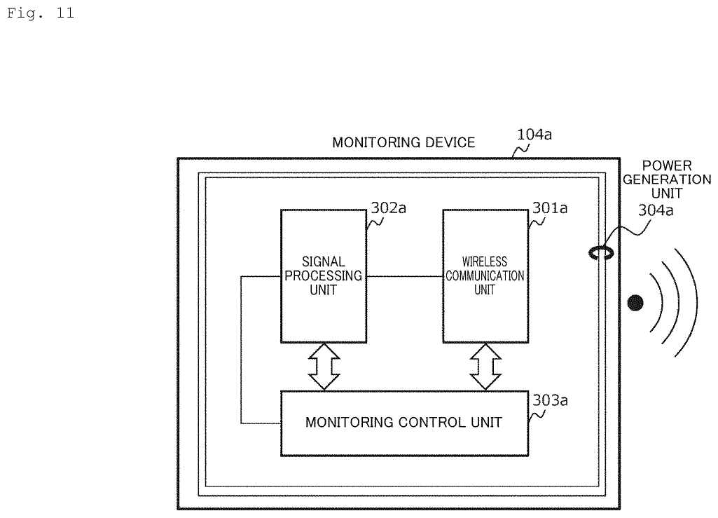

FIG. 11 illustrates a configuration example of the monitoring device 104a. The monitoring device 104a is added or attached to the n wireless LAN access points 101a monitored and controlled by the wireless LAN controller 102a. Here, e an IP address is not issued to the monitoring device 104a by the DHCP server of the wireless LAN access point 101a, a predetermined fixed IP address is assigned, and the monitoring device 104a performs processing for responding to the life and death check (ping) from the wireless LAN access point 101a. The monitoring device 104a establishes a link with the wireless LAN access point 101a for communication.

In FIG. 11, the monitoring device 104a added or attached to the wireless LAN access point 101a includes a wireless communication unit 301a, a signal processing unit 302a, a monitoring control unit 303a, and a power generation unit 304a. Here, the wireless communication unit 301a, the signal processing unit 302a, the monitoring control unit 303a, and the power generation unit 304a correspond to the wireless communication unit 301, the signal processing unit 302, the monitoring control unit 303, and the power generation unit 304 in FIG. 5, respectively, operates as in the monitoring device 104 of FIG. 5 except that a wireless LAN frame is handled as a radio frame. Hereinafter, portions different from FIG. 5 will be described.

The wireless communication unit 301a converts the wireless LAN frame output from the signal processing unit 302a into radio waves, transmits the radio waves to the wireless LAN access point 101a, converts the radio waves received from the wireless LAN access point 101a into a wireless LAN frame, and outputs the wireless LAN frame to the signal processing unit 302a. For example, the wireless communication unit 301a performs wireless communication with the added or attached wireless LAN access point 101a, and returns a response to the wireless LAN access point 101a when the wireless communication unit 301a receives the life and death check (ping) from the wireless LAN access point 101a. When the ping is not received, no response is returned.

The signal processing unit 302a converts the transmission signal output from the monitoring control unit 303a into a wireless LAN frame, outputs the wireless LAN frame to the wireless communication unit 301a, and converts the wireless LAN frame input from the wireless communication unit 301a into a reception signal. For example, the signal processing unit 302a receives the wireless LAN frame in which the ping signal received from the wireless LAN access point 101a by the wireless communication unit 301a is stored, converts the wireless LAN frame into a ping signal, and outputs the ping signal to the monitoring control unit 303a. On the other hand, the signal processing unit 302a converts the ping response signal output from the monitoring control unit 303a into a wireless LAN frame, and transmits the wireless LAN frame from the wireless communication unit 301a to the wireless LAN access point 101a. Further, the signal processing unit 302a converts information transmitted or received between the monitoring control unit 303a and the wireless LAN access point 101a into the wireless LAN frame, and transmits the wireless LAN frame using the wireless communication unit 301a when necessary, such as when establishing a link with the wireless LAN access point 101a.

The monitoring control unit 303a inputs or outputs the monitoring control information to or from the wireless communication unit 301a and the signal processing unit 302a and manages the information, and performs communication with the added or attached monitoring control unit 203a of the wireless LAN access point 101a. Specifically, when a ping request is received from the wireless LAN access point 101a, the monitoring control unit 303a performs processing for returning a ping response to the wireless LAN access point 101a or processing such as establishment of a link with the wireless LAN access point 101a. The monitoring control unit 303a holds a predetermined IP address, which is used as a transmission source address of the wireless LAN frame processed by the signal processing unit 302a.

Since the power generation unit 304a is the same as the power generation unit 304 described with reference to FIG. 5, repeated description will be omitted.

Thus, in the wireless LAN monitoring system 100a according to the present embodiment, the monitoring device 104a is added or attached to the wireless LAN access point 101a, and performs the life and death check using ping with the wireless LAN access point 101a. Since the wireless LAN access point 101a transmits the device state including the result of the life and death check to the wireless LAN controller 102a, the wireless LAN controller 102a can detect the hardware failure of the wireless communication unit 201a of the wireless LAN access point 101a.

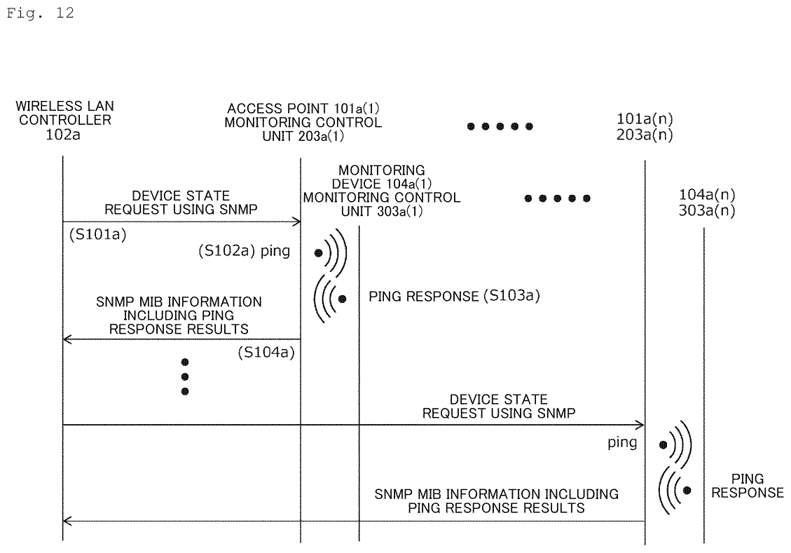

FIG. 12 illustrates an example of a monitoring sequence of the wireless LAN monitoring system 100a according to the present embodiment. The sequence of FIG. 12 is executed by the wireless LAN controller 102a, the monitoring control unit 203a of the wireless LAN access point 101a, and the monitoring control unit 303a of the monitoring device 104a.

Here, the monitoring sequence of the wireless LAN monitoring system 100a illustrated in FIG. 12 is basically the same as the monitoring sequence of the wireless communication monitoring system 100 described with reference to FIG. 6. Hereinafter, portions different from FIG. 6 will be described.

In step S101a, the wireless LAN controller 102a requests the monitoring control unit 203a of each wireless LAN access point 101a for information on the device state by SNMP one by one in order to monitor the n wireless LAN access points 101a that are management targets (device state request).

In step S102a, the monitoring control unit 203a of each wireless LAN access point 101a that has received the device state request using SNMP from the wireless LAN controller 102a transmits a ping for performing a life and death check to the IP address assigned to the monitoring control unit 303a of the monitoring device 104a in advance. The transmitted ping passes through the wireless communication unit 201a from the main signal processing unit 202a of the wireless LAN access point 101a, is transmitted as the radio waves of the wireless LAN, is received by the wireless communication unit 301a of the monitoring device 104a, and reaches the monitoring control unit 303a of the monitoring device 104a via the signal processing unit 302a.

In step S103a, when the monitoring control unit 303a of the monitoring device 104a receives the ping from the wireless LAN access point 101a, the monitoring control unit 303a returns a response to the ping to the wireless LAN access point 101a. The ping response transmitted from the monitoring control unit 303a of the monitoring device 104a is converted into a wireless LAN frame by the signal processing unit 302a, and transmitted as the radio waves of the wireless LAN from the wireless communication unit 301a to the wireless LAN access point 101a. The ping response received by the wireless communication unit 201a of the wireless LAN access point 101a reaches the monitoring control unit 203a via the main signal processing unit 202a. The wireless LAN access point 101a that has received the ping response recognizes that the life and death check of the monitoring device 104a has succeeded.

In step S104a, the monitoring control unit 203a of the wireless LAN access point 101a transmits SNMP MIB information such as held device state of the host device or alarm, including the result of ping with the monitoring device 104a ((presence or absence of the response or success and failure of the life and death check), to the wireless LAN controller 102a in response to the device state request in step S101a (corresponding to the device state response in FIG. 6). Here, the wireless LAN access point 101a includes a memory for managing the SNMP MIB information. The memory is the same as that of the wireless LAN access point 701a of the comparative example to be described below.

Then, the above-described sequence is similarly executed for the n wireless LAN access points 101a from the wireless LAN access point 101a(1) to the wireless LAN access point 101a(n).

The wireless LAN controller 102a collects device state of each wireless LAN access point 101a, including the result with ping with the monitoring device 104a added or attached to each of the n wireless LAN access points 101a. The wireless LAN controller 102a detects a failure including the hardware failure of the wireless communication unit 201a of the wireless LAN access point 101a, on the basis of the device state of each wireless LAN access point 101a including the result of ping with the monitoring device 104a added or attached to the wireless LAN access point 101a. This makes it possible to detect the hardware failure of the wireless communication unit 201a of the wireless LAN access point 101a, which was difficult to detect only with the SNMP MIB information.

Thus, in the wireless LAN monitoring system 100a according to the present embodiment, the wireless LAN access point 101a performs the life and death check using ping with the monitoring device 104a added or attached to the host device, and notifies the wireless LAN controller 102a of the device state of the host device including the ping result. The wireless LAN controller 102a can detect the failure including the hardware failure of the wireless communication unit 201a of the wireless LAN access point 101a on the basis of the device state including the ping result.

Here, in the description of FIG. 12, a timing of the ping performed on the monitoring control unit 303a of the monitoring device 104a by the monitoring control unit 203a of the wireless LAN access point 101a is a time when the device state request from the wireless LAN controller 102a has been received. That is, the timing when the device state request is received is a trigger for ping transmission. However, the monitoring control unit 203a of the wireless LAN access point 101a may regularly transmit a ping to perform the life and death check of the monitoring device 104a regardless of whether or not there is a device state request from the wireless LAN controller 102a as illustrated in FIG. 12. In this case, the wireless LAN access point 101a can appropriately notify the wireless LAN controller 102a of a result of no ping response. When there is a ping response, the monitoring device 104a may not transmit the result of the ping response to the wireless LAN access point 101a.

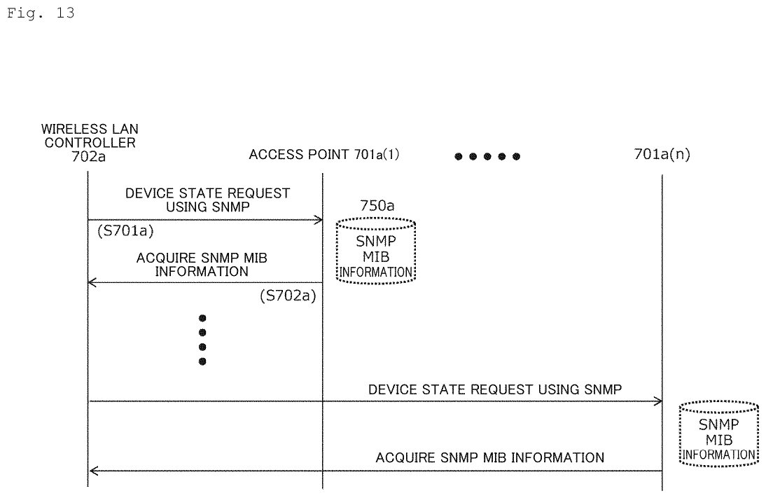

FIG. 13 illustrates an example of a monitoring sequence of a wireless LAN monitoring system 700a of a comparative example. In FIG. 13, the wireless LAN controller 702a executes the following processing for a specific wireless LAN access point 701a.

The wireless LAN controller 702a requests the wireless LAN access point 701a for the device state using SNMP in order to ascertain the device state of the wireless LAN access point 701a (S701a).

The wireless LAN access point 701a, which receives the device state request using SNMP, extracts information corresponding to the requested device state from the SNMP MIB information (memory 750a) managed by the wireless LAN access point 701a, and returns the information to the wireless LAN controller 702a (S702a). Here, the wireless LAN access point 701a includes a memory 750a for managing the SNMP MIB information.

The wireless LAN access point 701a regularly inputs or outputs the monitoring control information between the monitoring control unit and each block within the host device, and continuously updates the SNMP MIB information so that the information is always the latest information. Here, also in the wireless LAN access point 101a according to the present embodiment described above, the monitoring control unit 203 regularly inputs or outputs the monitoring control information between the wireless communication unit 201 and the main signal processing unit 202, and continues to update the SNMP MIB information so that the information is always the latest information.

The wireless LAN controller 702a monitors all the wireless LAN access points 701a by executing the above processing for all the wireless LAN access points 701a.

In the related art, monitoring using SNMP capable of acquiring further detailed device status is used together in order to detect an abnormality of the wireless LAN access point 701a together with the life and death check (ping) to the wireless LAN access point 701a.

Since the hardware failure or traffic flow information can be monitored by acquiring the MIB for checking various types of status information defined in the device using SNMP, it is possible to remotely detect the hardware failure reflected in the MIB.

However, it is difficult to detect hardware failure that is not reflected in the MIB. For example, when no main signal traffic flows through the wireless LAN access point 101a, it is impossible to distinguish between whether the radio waves of the wireless LAN are not transmitted due to the hardware failure and whether the hardware is normal but there are simply no users.

Thus, the wireless LAN monitoring system 700a of the comparative example cannot detect the hardware failure in some cases.

On the other hand, in the wireless LAN monitoring system 100a according to the present embodiment described with reference to FIG. 12, since the monitoring device 104a is added or attached to the wireless LAN access point 101a and the life and death check using ping is performed between the wireless LAN access point 101a and the monitoring device 104a, it is possible to also detect the failure as described above on the basis of the device state response including the result of the ping response. For example, when the radio waves of the wireless LAN are not transmitted due to the hardware failure of the wireless communication unit 201a of the wireless LAN access point 101a, there is no ping response from the monitoring device 104a, and thus, a determination can be made that the hardware failure is likely to occur. When the hardware is normal and there are simply no users, there is the life and death check response, and thus, a determination can be made that the wireless communication unit 201a of the wireless LAN access point 101a is normal.

Thus, the wireless LAN monitoring system 700a of the comparative example differs from the wireless LAN monitoring system 700a in that the device state including the result of the life and death check using ping is transmitted to the wireless LAN controller 102a. In the wireless LAN monitoring system 100a according to the present embodiment described with reference to FIG. 12, processing of transmitting the device state request using SNMP or MIB information stored in a memory of the wireless LAN access point 101a to the wireless LAN access point 101a is performed, similar to the comparative example in FIG. 13.

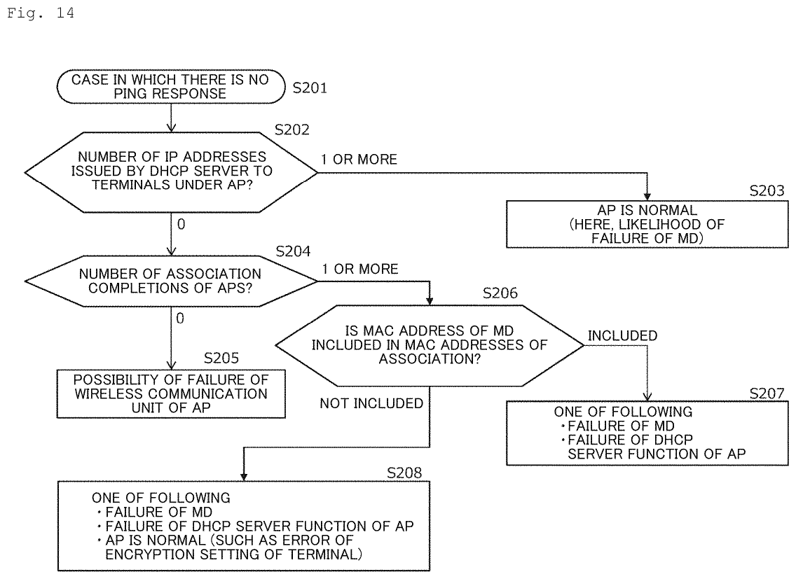

FIG. 14 illustrates an example of failure isolation processing in the wireless LAN monitoring system 100a. This isolation processing is executed by the wireless LAN controller 102a. The wireless LAN controller 102a according to the present embodiment can also be realized by a computer and a program, and the program can be recorded on a recording medium or can be provided through a network. The same applies to the remote monitoring control device 102 described in FIG. 1.

FIG. 14 illustrates processing when the wireless LAN access point 101a fails to perform the ping life and death check on the monitoring device 104a, that is, when there is no ping response from the monitoring device 104a. The failure of the monitoring device 104a is also assumed here. Further, it is assumed that the IP address of the monitoring device 104a is fixed and does not fall within an IP address range issued by the DHCP server of the wireless LAN access point 101a. Here, in FIG. 14, the wireless LAN access point 101a is abbreviated as AP, and the monitoring device 104a is abbreviated as MD.

In step S201, when there is no response to the ping to the monitoring device 104a added or attached to the wireless LAN access point 101a, the wireless LAN controller 102a executes the processing from step S202 and subsequent steps to perform a failure determination.

In step S202, the wireless LAN controller 102a checks the number of IP addresses issued by the DHCP server with respect to terminals (wireless terminals such as smartphones) under the control of the wireless LAN access point 101a that did not receive a ping response. When the number of IP addresses issued by the DHCP server is 0, processing of step S204 is executed, and when the number is 1 or more, processing of step S203 is executed. When the number of IP addresses issued by the DHCP server is 0, some failure occurs in the wireless LAN access point 101a or a failure (a fault or the like) in the monitoring device 104a is suspected.

In step S203, since the number of issued IP addresses is 1 or more, the wireless LAN controller 102a can know that a terminal other than the monitoring device 104a has normally received the IP address issued from the wireless LAN access point 101a, and determine that the wireless LAN access point 101a is operating normally. However, since there is no ping response from the monitoring device 104a, the wireless LAN controller 102a determines that some failure including a fault of the monitoring device 104a is likely to occur.

In step S204, the wireless LAN controller 102a checks the association (link establishment information) of the wireless LAN access point 101a that did not respond to the ping, and checks the number of successful associations (link has been established). Here, the wireless LAN access point 101a manages MAC addresses of the associated wireless LAN terminals. When the number of associated MAC addresses is 0, processing of step S205 is executed, and when the number is 1 or more, processing of step S206 is executed.

In step S205, the wireless LAN controller 102a determines that a failure is likely to occur in the wireless communication unit 201a of the wireless LAN access point 101a. Specifically, the wireless LAN controller 102a determines that the wireless communication unit 201a of the wireless LAN access point 101a is likely to be unable to transmit or receive the radio waves of the wireless LAN and that the hardware failure of the wireless communication unit 201a is suspected.

In step S206, the wireless LAN controller 102a checks whether or not the MAC address of the monitoring device 104a is included in the associated MAC address. When the MAC address of the monitoring device 104a is included in the associated MAC address, the processing of step S207 is executed, and when the MAC address is not included, the processing of step S208 is executed.

In step S207, the wireless LAN controller 102a determines one of the following.
Failure of the monitoring device 104a
Failure in the DHCP server function of the wireless LAN access point 101a

That is, the wireless LAN access point 101a determines a failure of the monitoring device 104a or a failure of the DHCP server function when an IP address is not issued despite association completion, there are one or more associated MAC addresses, and the MAC address of the monitoring device 104a is included in the MAC addresses.

In step S208, the wireless LAN controller 102a determines that there is one of the following.
Failure of the monitoring device 104a
Failure in the DHCP server function of the wireless LAN access point 101a
The wireless LAN access point 101a is normal, but an encryption setting of the terminal is likely to be erroneous (that is, a likelihood of a setting error or a data error due to noise, or the like, which is not a hardware failure)

Thus, in the present embodiment, the wireless LAN access point 101a has a function of the DHCP server, and notifies the wireless LAN controller 102a of the result (presence or absence of the response) of the life and death check using ping to the monitoring device 104a added or attached to the wireless LAN access point 101a, wireless LAN link establishment history information (the number of associations) between the host device and monitoring device 104a, and IP address issuing history information (number of IP addresses) of the DHCP server.

The wireless LAN controller 102a can combine the result of the life and death check notified from the wireless LAN access point 101a, the link establishment history information, and the IP address issuing history information to isolate a failure location including the hardware failure of the wireless communication unit 201a of the wireless LAN access point 101a. Accordingly, the wireless LAN monitoring system 100a according to the present embodiment can detect the failure including hardware failure of the wireless communication unit 301a of the wireless LAN access point 101a, which are difficult to detect with related art.

### Other Application Examples

The wireless communication monitoring system 100 according to the present embodiment can be applied to a mobile phone base station device in which the number of terminals fluctuates, or can be applied to a base station device in satellite communication, as application examples other than the wireless LAN system described with reference to FIGS. 11 to 14.

As described above in the embodiment, in the wireless communication monitoring system 100 according to the present embodiment, the monitoring device 104 is added or attached to the wireless communication device 101, and the result of the life and death check to the monitoring device 104 from the wireless communication device 101 is included in the device state response of the related art, in addition to a monitoring method for the wireless communication device 701 of the related art in which a remote monitoring control device 702 of the related art issues a device state request to the wireless communication device 701. This makes it possible for the remote monitoring control device 102 to detect a failure that does not appear in information obtained from the device state request and to detect a failure that is difficult to detect in the related art.

In particular, when the wireless communication monitoring system 100 according to the present embodiment is applied to a wireless LAN system, not only acquisition of the device state of the wireless LAN access point 101a using SNMP, but also the life and death check (ping) between the wireless LAN access point 101a and the monitoring device 104a is performed by using the radio waves of the wireless LAN. Accordingly, when the ping fails even though the wireless LAN access point appears to be operating normally in the SNMP MIB, the wireless LAN controller 102a can determine that the failure including the hardware failure of the wireless communication unit 201a of the wireless LAN access point 101a is likely to occur.

As described above in each embodiment, with the wireless communication monitoring system, the wireless communication monitoring method, and the monitoring device according to the present invention, it is possible to detect a failure that cannot be detected from information obtained from a device state request to a wireless communication device of the related art, by adding or attaching the monitoring device to the wireless communication device, and performing the life and death check between the wireless communication device and the monitoring device.

### REFERENCE SIGNS LIST

100, 700 Wireless communication monitoring system
100a, 700a Wireless LAN monitoring system
101, 701 Wireless communication device
101a, 701a Wireless LAN access point
102, 702 Remote monitoring control device
102a, 702a Wireless LAN controller
103, 103a, 703, 703a Network
104, 104a Monitoring device
201, 201a Wireless communication unit
202, 202a Main signal processing unit
203, 203a Monitoring control unit
204 Signal distribution unit
301, 301a: Wireless communication unit
302, 302a Signal processing unit
303, 303a Monitoring control unit
304 Power generation unit
750a Memory

1. A wireless communication monitoring system, comprising:
a remote monitoring control device, including:
circuitry configured to perform a determination of a failure including the hardware failure of wireless circuitry on a basis of a device state response of the wireless circuitry including a result of a life and death check received from the wireless circuitry.

2. The wireless communication monitoring system according to claim 1, wherein:
the wireless communication circuitry includes a wireless LAN access point having a DHCP server function, and is configured to notify the remote monitoring control device of the result of the life and death check using pinging to a monitor at the wireless circuitry, link establishment history information of a wireless LAN between the wireless communication circuitry and the remote monitoring control device, and IP address issuing history information to a DHCP server, and
the remote monitoring control device includes a wireless LAN controller to monitor and control a wireless LAN system, and combines the result of the life and death check with the monitor notified from the wireless LAN access point, the link establishment history information, and the IP address issuing history information to perform a determination of a failure including a hardware failure of the wireless circuitry of the wireless LAN access point.

3. The wireless communication monitoring system according to claim 2, wherein the remote monitoring control device includes circuitry configured to:
perform a determination of a failure location on the basis of the number of IP addresses issued by the DHCP server, the number of MAC addresses for which the link has been established, and whether or not the MAC address of the monitor is included in the MAC address for which the link has been established when there is no response to the ping from the monitor,
determine that the wireless LAN access point is normal when the number of IP addresses issued by the DHCP server is 1 or more,
determine that there is a failure in the wireless circuitry of the wireless LAN access point when the number of IP addresses issued by the DHCP server is 0 and the number of MAC addresses for which the link has been established is 0,
determine that there is a failure in the DHCP server of the wireless LAN access point or the monitor when the number of IP addresses issued by the DHCP server is 0, the number of MAC addresses for which the link has been established is 0, and the MAC address of the monitor is included in the MAC address for which the link has been established, and
determines that there is a failure in any one of the DHCP server of the wireless LAN access point, the monitor, and encryption setting of a terminal connected to the wireless LAN access point when the number of IP addresses issued by the DHCP server is 0, the number of MAC addresses for which the link has been established is 0, and the MAC address of the monitor is not included in the MAC address for which the link has been established.

4. A wireless communication monitoring method for monitoring a hardware failure of wireless circuitry of at least one wireless communication device using a remote monitoring control device,
transmitting or receiving, by the wireless communication device, a predetermined radio signal to or from a monitor added or attached to a host device to perform a life and death check for checking an operation; and
performing a determination of a failure including the hardware failure of the wireless communication unit of the wireless communication device on the basis of a device state response of the wireless communication device including a result of the life and death check received from the wireless communication device.

5. The wireless communication monitoring method according to claim 4, wherein:
the wireless communication device includes a wireless LAN access point having a DHCP server function, and notifies the remote monitoring control device of the result of the life and death check using pinging to the monitor, link establishment history information of a wireless LAN between the host device and the monitor, and IP address issuing history information to the DHCP server, and
the remote monitoring control device includes a wireless LAN controller configured to monitor and control a wireless LAN system, and combines the result of the life and death check with the monitor notified from the wireless LAN access point, the link establishment history information, and the IP address issuing history information to perform a determination of a failure including a hardware failure of the wireless communication unit of the wireless LAN access point.

6. The wireless communication monitoring method according to claim 5,
wherein the remote monitoring control device performs a determination of a failure location on the basis of the number of IP addresses issued by the DHCP server, the number of MAC addresses for which the link has been established, and whether or not the MAC address of the monitor is included in the MAC address for which the link has been established when there is no response to the ping from the monitor,
determines that the wireless LAN access point is normal when the number of IP addresses issued by the DHCP server is 1 or more,
determines that there is a failure in the wireless communication unit of the wireless LAN access point when the number of IP addresses issued by the DHCP server is 0 and the number of MAC addresses for which the link has been established is 0,
determines that there is a failure in the DHCP server of the wireless LAN access point or the monitor when the number of IP addresses issued by the DHCP server is 0, the number of MAC addresses for which the link has been established is 0, and the MAC address of the monitor is included in the MAC address for which the link has been established, and
determines that there is a failure in any one of the DHCP server of the wireless LAN access point, the monitor, and encryption setting of a terminal connected to the wireless LAN access point when the number of IP addresses issued by the DHCP server is 0, the number of MAC addresses for which the link has been established is 0, and the MAC address of the monitor is not included in the MAC address for which the link has been established.

7. A monitor comprising:
power generation circuitry added or attached to a wireless communication device and configured to generate power required for an operation using radio waves radiated from the wireless communication device;
wireless communication circuitry configured to perform wireless communication with the wireless communication device; and
monitoring control circuitry configured to return a response signal when a predetermined life and death check signal for checking the presence or absence of an operation is received from the wireless communication device via the wireless communication circuitry.

8. The monitor according to claim 7,
wherein the monitoring control circuitry performs establishment of a link of a wireless LAN link with a wireless LAN access point using a predetermined fixed IP address from the wireless LAN access point, and returns a response signal when the monitoring control circuitry receives a ping signal from the wireless LAN access point.
